(19) United States
(12) Patent Application Publication
(10) Pub. No.: US 2010/0250382 A1
(43) Pub. Date: Sep. 30, 2010

(54) PAYMENT PROVIDER MONITORED PAYMENT BUTTON

(75) Inventor: Ketan Babaria, San Jose, CA (US)

Correspondence Address: Haynes and Boone, LLP;IP Section, 2323 Victory Avenue, SUITE 700, Dallas, TX, 75219, US

(73) Assignee: eBay Inc., San Jose, CA (US)

(21) Appl. No.: 12/411,147

(22) Filed: Mar. 25, 2009

(51) Int. Cl. G06Q 30/00; G06Q 10/00; G06Q 20/00; G06F 17/30

(52) U.S. Cl. 705/26; 705/28; 705/30; 705/40; 707/E17.044

(57) ABSTRACT

A payment button is generated by a payment provider, and information associated with the payment button is stored with the payment provider, along with a unique identifier for the information. A merchant places the button on a webpage, and users can click on it to process a payment to the merchant. The merchant can change or track information, such as inventory, associated with the button on the payment provider site and can receive updates based on changes in the information, which may also be updated by users clicking on the button to purchase items associated with the button.

### BACKGROUND

1. Technical Field

The present disclosure generally relate to systems and methods for conducting network-based or online financial transactions, for example payment for items (goods or services) offered for sale over a network, for example the internet.

2. Related Art

Merchants, service providers, and/or private individuals, may offer items for sale on a web page appearing on a website accessible by a browser via the internet. The webpage may include graphics and/or text indicating a particular item offered for sale and may include a link selectable by a customer for initiating the sale and/or purchase. A customer may initiate a financial transaction to pay for the item by selecting the link in an appropriate manner. The link, for example a graphical “button,” may be selected by navigating to the button with a cursor and pressing a key on a keyboard, clicking a mouse, or by any other available means or method available on the particular graphical user interface (GUI) and/or the particular device being used to access the webpage. Selecting the link or “pressing” the button may initiate a payment transaction to be executed through payment services provided by a third-party provider. The third-party payment provider may use payment and account information previously provided by the customer to transfer money to an account using account information previously provided by the merchant. Such third-party payment services include, for example, services provided by PayPal Inc. of San Jose, Calif.

The merchants may manually generate the computer code to display the buttons and to represent particular items offered for sale by copying or inputting appropriate computer code, for example HTML code, representative of the item for sale, the price of the item, and other information related to the item offered for sale. Merchants may also copy button code from a service that helps create the button code. Manually creating buttons and pasting the code creates a risk of input errors, updating and editing errors, encryption errors, and a risk of fraudulent purchases by customers or other users or “hackers” with the requisite knowledge on how to change or alter such code prior to making a fraudulent purchase. For example, a hacker may acquire and alter the code to reduce the listed price for an item, make a purchase, and be charged the reduced price based on the altered code or simply alter the code to indicate the item has been paid for. A method of creating, providing, and maintaining such transaction links/buttons with reduced risk of error or fraud may be desired.

### SUMMARY

According to one embodiment, a payment provider generates or creates a button based on information about a product or service received from a merchant and stores the information on the payment provider site. The information may include a description, number available, and price. A unique identifier is generated and associated with the button. When the button is created, the merchant can copy it onto the merchant web page using a single line of code to associate the button with the information stored in the payment provider site. Users or customers may then click on the button on the merchant site to initiate and process a payment to the merchant. After checkout, information associated with the transaction may be updated in the payment provider database. The payment provider may send the merchant any updates, such as low or depleted inventory. The merchant may also access the information, such as by entering the unique identifier, to track or change the information.

Because the information associated with the button is stored with the payment provider, instead of hard coded into the merchant website, the risk of fraudulent changes being made to the code of a network-based store may be reduced, resulting in a reduced risk of fraudulent purchases. Merchants also may more easily generate buttons or links for placement on a network-based store, more easily make changes to the information associated with the button, track information, such as inventory, associated with the button, and receive updates based on changes to the information, such as low inventory.

These and other features and aspects of the present invention will be more readily apparent from the detailed description of the embodiments set forth below taken in conjunction with the accompanying drawings.

### BRIEF DESCRIPTION OF THE FIGURES

FIG. 1 illustrates an overview of an example system for selling, buying, and paying for items offered over a network according to one embodiment.

FIG. 2 illustrates a block diagram of the system in FIG. 1 according to one embodiment.

FIG. 3 illustrates an example embodiment of a system of offering an item for sale on a network-based store and for initiating purchase of and payment for the item over a network.

FIG. 4 illustrates an example embodiment of a display of a button as displayed on a user device display when accessed by a customer through a network-based store.

FIG. 5 illustrates various options a merchant may exercise in creating a button for display in a network-based store.

FIG. 6 illustrates an example embodiment of a method for providing a button for a network-based store.

Exemplary embodiments and their advantages are best understood by referring to the detailed description that follows. It should be appreciated that like reference numerals are used to identify like elements illustrated in one or more of the figures, wherein showings therein are for purposes of illustrating exemplary embodiments and not for purposes of limiting the same.

### DETAILED DESCRIPTION

Embodiments of the present disclosure relate generally to systems and methods for a merchant to sell or offer to sell an item over a network, for a customer to initiate a purchase of the item when accessing or navigating to a network-based store, and for arranging payment for the selected item(s) through a third-party payment services provider that arranges to transfer money from a customer account to a merchant account. Embodiments relate to third-party hosting of button information for items or services offered for over a network. This feature may allow the merchant to save the button settings on the third-party site and create only one line of code that ties the button settings and the button code together. A merchant may log into an account with the third-party host, change or edit various settings (e.g. price, currency, shipping, tax, etc.) on the hosted site without changing their live site. When a customer clicks on the button, the button settings may be retrieved from the third-party host site and the customer may check out with the updated settings.

Third-party hosting of the button information may enable a third-party host to provide additional services to a merchant, for example, inventory management, revenue tracking, and encryption.

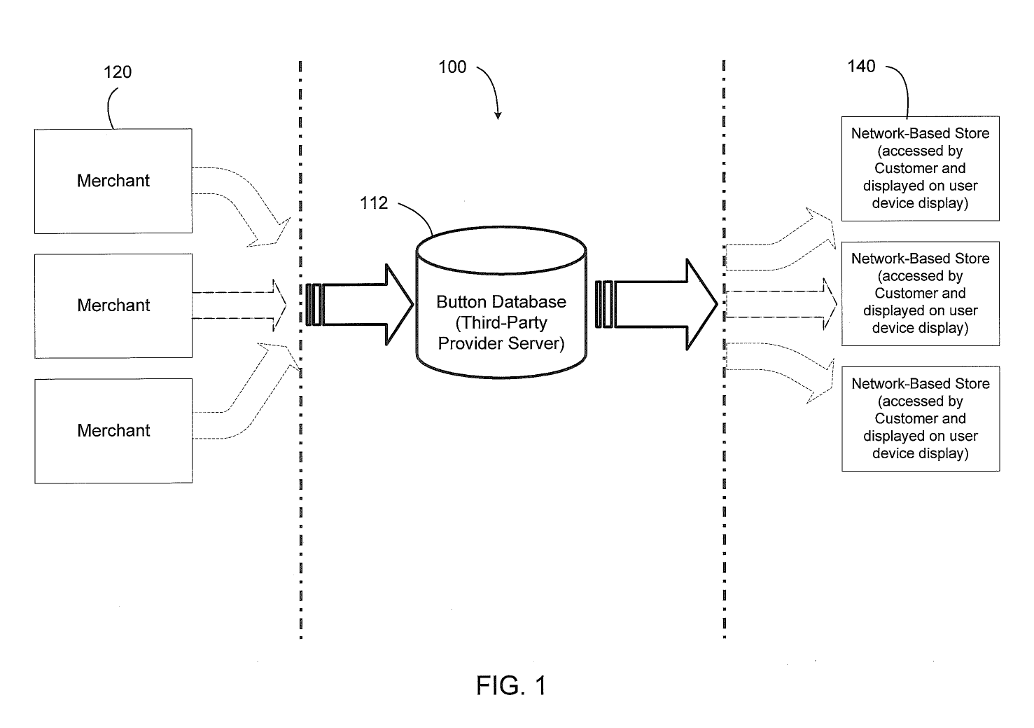

FIG. 1 illustrates an overview of a system 100 for selling, buying, and paying for items offered over a network. The system 100 may include one or more servers 120 operated by one or more merchants, a database 112 operated by a third-party provider, such as PayPal Inc., of San Jose, Calif., and one or more user devices 140 operated by customers or users.

Registered merchants provide information related to items to be offered for sale to the customer. Such information may be stored in database 112. The information may be pushed to network-based stores and/or user devices 140 so that customers can access the network-based store to purchase an offered item. Storing the information in database 112 maintained by the third-party provider may reduce the likelihood of fraudulent purchases. Storing the information in database 112 may also enable the third-party provider to provide additional services of value to a merchant, such as inventory tracking, control, and reporting and maintaining sales records.

### Merchant

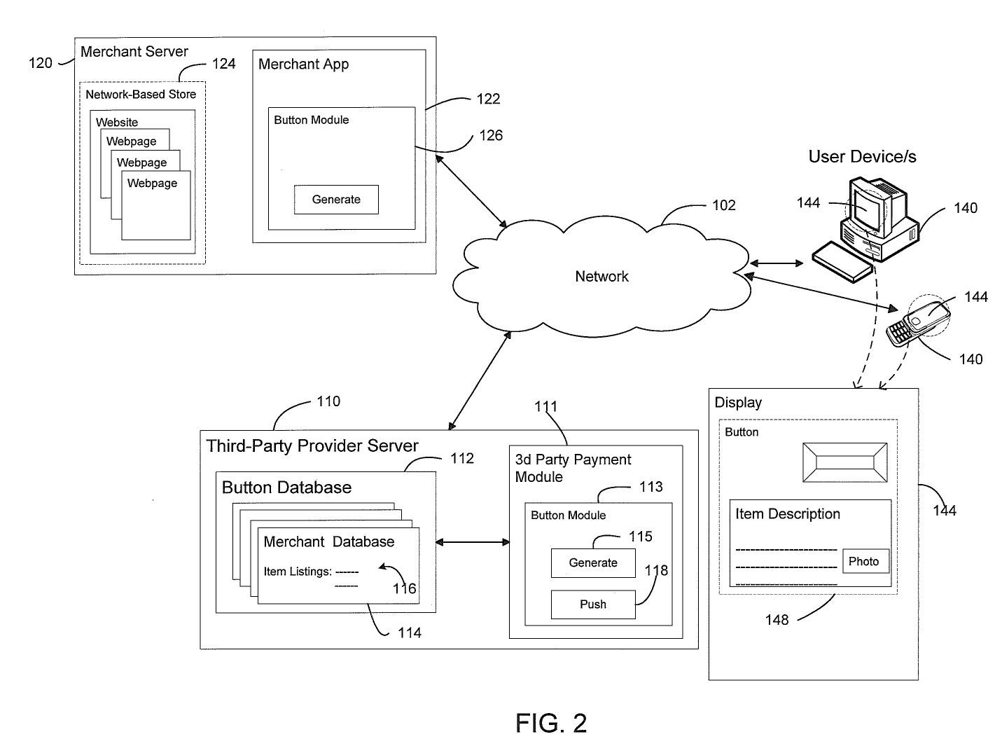

In an example embodiment, a merchant may be any retailer, wholesaler, service provider, or individual offering items for sale over a network or receiving payments from users or customers purchasing the items, or any developer or agent of the merchant working on behalf of the merchant. The merchant may provide an online or virtual market or store displayed, for example, a network-based store 122 (FIG. 2).

### Network-Based Store

In an example embodiment, network-based store 122 may comprise a web site or webpage or other target accessible via a network by a customer using a user device. The network-based store may be accessible via a link from an offline document, file or other electronic representation or may be accessible via a browser navigating on a network. In an example embodiment, a customer navigating to the network-based store by any means may select an item to purchase and arrange payment for the item by operating a virtual “button” or link represented on the network-based store.

In an example embodiment, an item or items may be any goods, services, subscriptions and recurring billings, donations, gift certificates, or any other type of item of value or perceived value, whether real or not, that may be offered on a network-based store. Moreover, although the word “store” is used here to refer to any network location, website, link or other virtual location from which at least one item may be offered in return for payment, promise of payment, or any other exchange of value or perceived value, whether by cash, electronic transfer, arrangement for a third-party credit provider to pay, or any other arrangement agreed on by the parties. The term store is not limited to commercial “stores” operated by businesses. A “store” may be operated by an individual or any entity offering at least one item for sale over a network. Similarly, the word purchase or buy throughout is not limited to payment to receive a tangible good, it includes payments for services, payments of debts, donations or gifts given with nothing in return, or anything for which a transfer of money or value or electronic representations of money or value may be transferred from one party (customer) to another party (merchant).

Throughout this specification, when the terms “website”, network location, or other term is used, it is to be understood that any other network location or place accessible through a network may also be understood to perform the function, for example network locations that do not appear on a website as such, but are accessible through offline links, or be redirection from a website, or may refer to any offline link or other mechanism through which the network-based store may be accessed, or may refer to the offline link and network-based store provided they operate in conjunction to permit a customer to use a user device to arrange a purchase and payment for an item offered through a network.

### Customer

In an example embodiment, a customer is any person or entity who accesses a network-based store over a network from a user device capable of viewing items offered for sale in the network-based store and initiating a purchase of and payment for an item offered for sale.

### Third-Party Provider

In an example embodiment, a third-party provider is any entity that provides services to arrange payment from a customer to a merchant for purchase of an item at a network-based store. An example of a third-party payment services provider is PayPal. A third-party payment provider may permit merchants and/or customers to register for and/or contract for payment services by providing sufficient financial account information for the third-party provider to execute transfers of money, credit, or other value from a customer account to a merchant account. Registered users may access the services using various security methods including, for example, entering personal identification numbers (PIN), cryptological keys, biometric identification, or any other means of identification designed to ensure that a user (merchant or customer) has permission to access services, receive payments, make payments, or update or revise subscription or registration information.

FIG. 2 illustrates a more detailed block diagram of system 100 for selling, buying, and paying for items offered over a network in one or more embodiments. A merchant may use a third-party payment module 122 or application to input and forward the information to the third-party provider. The input information may include a description of the item, price of the item, taxes, shipping costs, or any other information required by or optionally permitted by the third-party provider. The input information may be communicated to a server 110 maintained or operated by the third-party payment provider over a network 102, such as the Internet.

In an example embodiment, server 110 has a payment application or module 111 for providing third-party payment services to users including, for example, merchants and customers. The information input by a merchant may be received by and processed by the payment application 111. The information may be collected and stored in a database 112 maintained on the third-party provider server 110. For example, the information may be stored in a merchant database 114, containing all information related to a particular, corresponding merchant, and may be arranged in item listings 116, for example individual listings 116 for each item to be offered for sale.

An item listing 116 may include various information related to an item including, for example, price, description, inventory information, color, size, tax rate, options, or any other information related to the item. The payment application 111 or module may assign a unique identifier for each item listing stored in the database 112. In an example embodiment, the unique identifier may include a merchant ID and an item ID which together uniquely identify an item. The unique identifiers may be generated by a “button” module or application 113 and may be provided to the merchants.

In an example embodiment, the button module 113 may generate “buttons” 117 to be associated with items offered or to be offered for sale on a merchant's network-based store. The buttons 117 may comprise a file, code, group of electronically stored information that will display a link or button to be selected to initiate a purchase and may also provide for the display of any pertinent item information from the item listing that is desired to be displayed, for example item name, prices, options, or other information.

In an example embodiment, a merchant may copy a button 117 or button code provided by the merchant and associated with a particular item identified by a unique identifier into code representative of a network-based store 124, for example a website or webpage. When a user navigates to the network-based store 124, the button 117 causes a graphic or textual link or button to be displayed, along with information from the item listing. Although the item listing information is stored at the database 112, the button 117 code may cause the third-party payment module and/or button module 113 to “push” 118 the information to the user device 140 to be displayed on a display or screen 144 of user device 140. Storing the information at the third-party server, instead of being typed directly into the code representative of the network-based store (for example in the HTML code of a website), may reduce the risk of fraudulent purchases. It may also make it more convenient for a merchant to create multiple buttons or similar buttons for various items, as the merchant may have access to stored buttons in order to use the buttons to place items for sale on network-based store 124. Stored information may also enable the third-party provider to provide additional services to a merchant including, for example, inventory control, monitoring, and reporting and/or sales and marketing information collection and reporting. In an example embodiment, a merchant may place “button” 117 onto network-based store 124 in order to offer an item for sale and provide a convenient method of payment for the item. A merchant may place the button 117 onto a network-based store, for example, by copying code provided by the third-party provider and pasting onto code for the network-based store, for example pasting into an HTML code representative of a website or a webpage. In an example embodiment, code for the button 117 placed on the network-based store may include the unique identifiers, for example a merchant ID and the item ID.

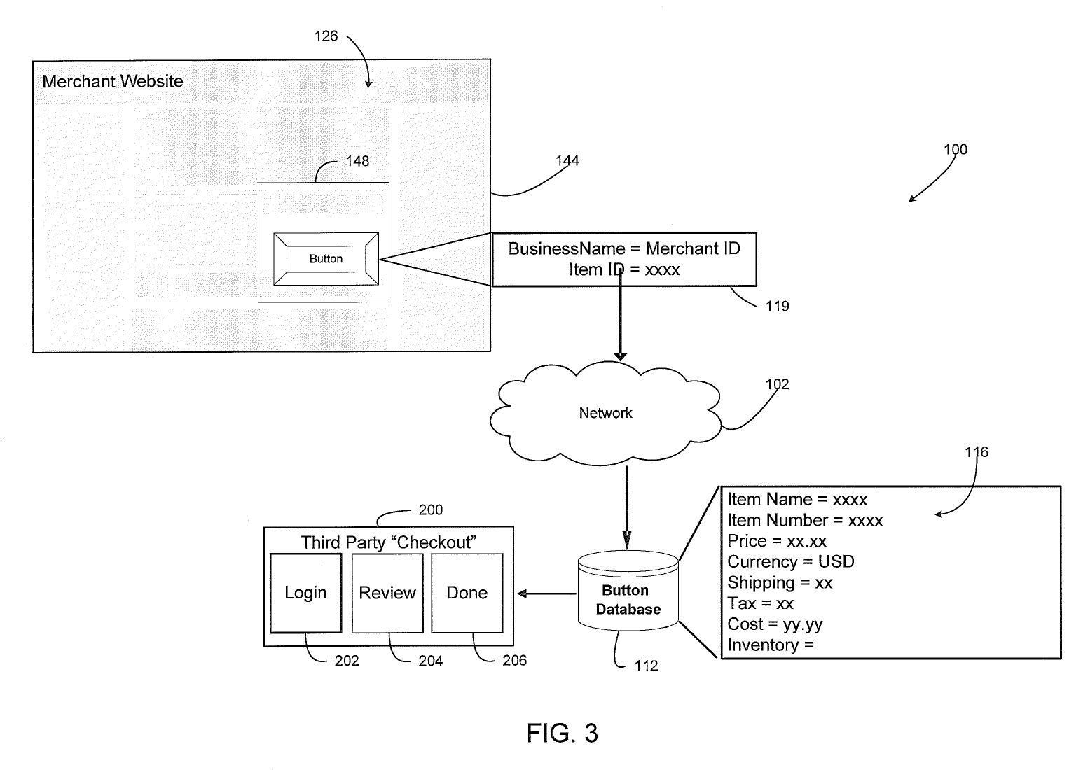

FIG. 3 illustrates an example embodiment of system 100 for offering an item for sale on a network-based store and for initiating purchase of and payment for the item over network 102. The system 100 may include network-based store 124, or website or webpage of the store, displayed on a user device display 144. A button 148 may be shown on the display. The button 148 may have been generated based on button code provided by a third-party provider and copied and pasted into the code that generates the displayed network-based store 124. The code may include the unique identifier 119 for the offered item, for example a merchant ID and an item ID.

The additional item information associated with the button displayed on the screen and stored in item listing 116 of third-party provider database 112 may be pushed to the user device and/or the network-based store over the network 102. The information may be pushed, for example, by using appropriate code to create the button, for example HTML code. A form post, for example, may post a unique item ID to the third-party provider's site. The third-party provider may take that item ID and pull all the information for a particular item. This may be possible, because as soon as a customer clicks on the buy button, he/she is taken to the third party provider's site.

In an example embodiment, the third-party provider may verify the purchase and arrange for payment for the item in a “checkout” function or flow 200—initiated by the user from the user device, and monitored and verified by the third-party provider. The checkout 200 may include having the customer login to their third-party provider account, review the terms of the purchase, and authorize the payment. After the customer has completed the check out, the third-party provider may transfer funds from a customer account to a merchant account and report the sale to the merchant.

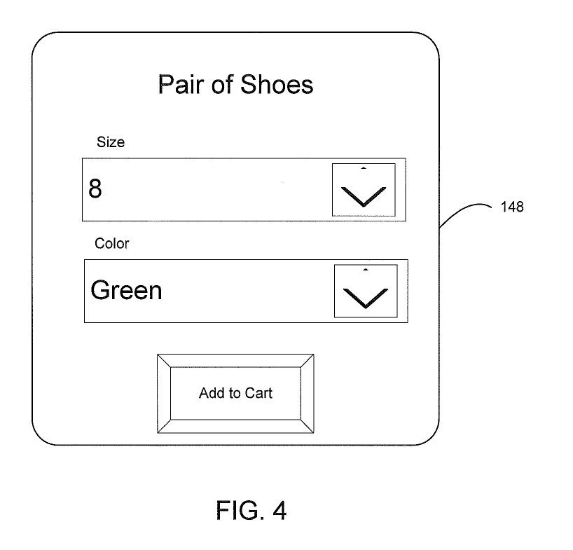

FIG. 4 illustrates an example embodiment of a display of button 148 as displayed on a user device display when accessed by a customer through a network-based store. In an example embodiment, the “button” may include the graphical representation of a button or text link, activation of which may initiate the purchase and payment processes. The button need not appear like a button and need not be pressed, or virtually pressed, for activation. The button refers to the entire code and/or display generated from the stored button code at the third-party provider including item listing information.

In an example embodiment, the display of the button may include the description of the item (Pair of Shoes), size selectable by a drop-down menu (8), and color, also selectable by a drop-down menu (Green). In other embodiments, button 148 may be customized by a merchant by inputting desired options through the button factory module 126 (FIG. 2).

### “Button Factory” API

Referring again to FIG. 2, in an example embodiment, the merchant server 120 may run a merchant application 122. The merchant application 122 may permit a merchant to connect with the third-party provider to set up network-based store 124, maintain its accounts, arrange for third-party payment, set up payment accounts, monitor payments, or other functions related to third-party payment services provided by a third-party provider.

In an example embodiment, the third-party payment module may include a “button” application or module 126, or button factory, with which the merchant can create links (such as an email link associated with a merchant or user's email) or buttons for display on network-based store 124 and through which a customer may initiate a purchase transaction for an item and initiate payment for the item. The merchant application 122 and or any parts or modules of the merchant application, for example the button module 126, may be stored on and run from the merchant server 120, or may stored on and remotely accessed from the third-party provider server 112 or other server, or may be run online or offline. The merchant application 122 and or any parts or modules of the merchant application may be run from the merchant server 120 or a device networked or attached to the merchant server 120. In an example embodiment, the merchant application 122 and or any parts or modules of the merchant application, for example the button module 126, may include an application program interface (API) accessible and operable by the merchant from the merchant server.

In an example embodiment, the merchant application 122 and or any parts or modules of the merchant application, for example the button module 126, may be a program, application, or other set of computer readable instructions or code that permits a merchant to initiate the creation and generation of “buttons” to be included in an online store for customers to arrange for purchase and payment of items offered for sale. The merchant application 122 may be provided by the third-payment provider, or be created to operate in coordination with the third-party provider application, or may exist on the third-party provider server 110 as part of the third-party application and accessible to a merchant over network 102 to perform functions of the button module 126.

The merchant application 122 may be operable in conjunction with the third-party provider application 111 for creating, generating, and displaying the item listings and buttons associated with the various items to be offered for sale. The merchant may input a list of items to be offered for sale and information related to the item to be included in item listing 116, for example descriptions of such items, prices for such items, inventory information for such items, and/or any other information related to the item. The merchant application 122 may communicate the input information to the third-party provider server and the third-party application 111 may generate the item listings 116 and store the item listings in the database 112 and/or the merchant database 114 corresponding to the particular merchant.

In an example embodiment, a merchant may use the button factory to generate the “button,” email link, or input information to be associated with a button generated by the third-party provider. In either case, the button and item listing information will be stored in the database 112 maintained and kept on servers controlled by the third-party provider. A merchant may also save buttons as templates to make the creation of additional buttons easier in the future.

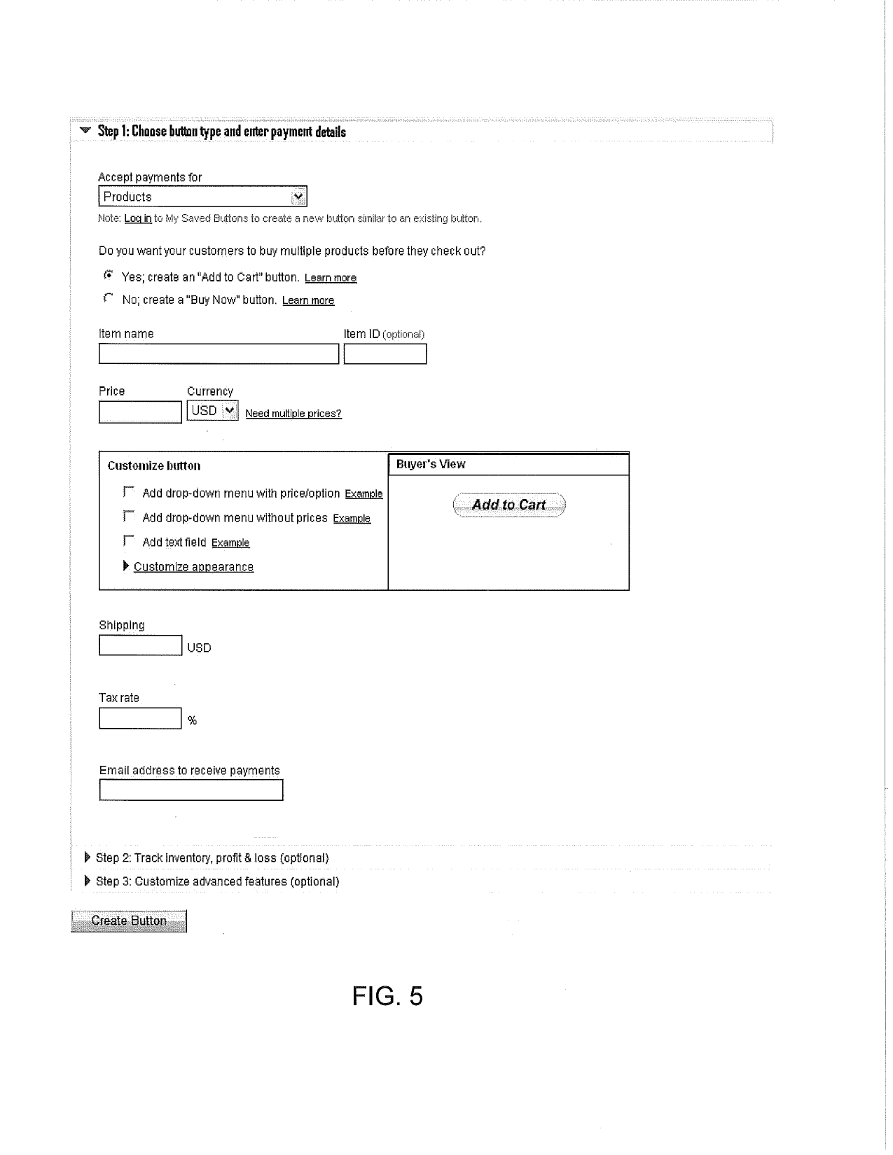

FIG. 5 illustrates various options that button module 126 may provide for a merchant when creating a button. The options may be displayed to the merchant using the button module 126. A merchant may input the item name and/or an item number. The item number may be assigned prior to entry by the merchant, or may be automatically be generated by the third-party provider and displayed on the merchant input form if it is the first time an item has been entered. The item number may be generated one at a time, as a button is created, or may be done in bulk, if a number of buttons are created at one time. If the item number was previously generated, the merchant can enter the item ID to track the associated item(s).

In an example embodiment, a merchant may select a type of transaction or payment to be supported by a button. Types of transactions to be supported by a buttons may include, for example, payments for goods, services, subscriptions and recurring billing, donations, gift certificates, or any other type of payment arrangement appropriate for an item offered for sale. Each different type of button may provide a different type of payment structure or services provided by the payment provider.

A merchant may elect to create an “add to cart” button or a “buy now” button, depending on whether the merchant wants a customer to make multiple purchases before checking out or not. The merchant may enter a unit price and currency to be used. The merchant may provide different options available to be selected by a customer depending on their preference. For example, various prices may be listed for various size, color, or other options selected by a user. The various prices and options may be accessible through drop-down menus by the customer when accessing the network-based store. A merchant may enter shipping rates, tax rates, e-mail address or account information for receipt of payments.

In an example embodiment, a merchant may choose from various other options available for the display of the button. For example, a merchant may choose to select a stock look for a button or upload their own graphics for the button. A merchant may select their own drop down menus, name the menus, select drop down menus with or without prices, or other options.

In an example embodiment, the screen shown to a merchant while creating buttons may generate a display of the button as seen by the customer, including any or all options selected. This may assist a merchant in designing or determining which options to include in a button display.

The merchant may request that buttons for the website be created. In an example embodiment, the button factory does not automatically place the button code on a merchant's network-based store, although the merchant may place the button code on the network-based store by copying and pasting button code provided by the third-party provider into the store's code, for example a website's HTML code. In an alternate embodiment, the third-party provider may provide a store authoring tool which may interact with the button application to automatically place a button or buttons corresponding to item listings of items offered for sale onto a merchant's network-based store.

By maintaining the database at the third-party provider server, fraudulent purchases may be prevented by preventing users from accessing item information included in the HTML code for a webpage—changing the item information—and making a fraudulent purchase. Since only the unique identifier appears in the code of the webpage, a user does not have access to change price or other information. Although a merchant may have access to item information to change, edit, remove, or add new items for sale, such access may be performed securely, with appropriate security measures, keys, PIN codes, or other identification procedures designed to restrict access to the database to a particular merchant associated with items in the database 112 or to the merchant database 114.

Referring again to FIG. 2, a customer may access or navigate to network-based store 124 using user device 140. A particular webpage, website, or other location where an item is offered for sale may appear on display 144 associated with the user device. User device 140 may be a computer, cell phone, smart-phone, laptop, or any other network communication device with hardware and software that enables the customer to use the device 140 to access and navigate a merchant's website 122. The display 144 may be a separate screen, built-in screen, cell phone or smart-phone display, or any other device arranged to display images and/or information accessed from a merchant website to display information and/or a link or button for executing a purchase transaction for such items.

In an example embodiment, button 148 may appear on the display 144. The button 148 may include the item description, price, link to initiate a purchase and payment, or other information from the item listing 116 stored in the database 112. A user or customer may select an item by executing the link, by pressing a keyboard or keypad key, or mouse or other screen navigation device to generate a signal or message indicative of a desire to purchase and pay for the item offered for sale. For example, where a link is a graphical representation of a button that may be selected by maneuvering a cursor over the button and pressing a mouse or a keyboard or keypad key, or virtual touch-screen key or any other medium available for selecting a link or button to initiate a financial transaction related to the sale of the selected item.

When a user selects or presses a link or button to initiate a purchase of an item offered for sale over the network, the user device 140 may generate or send a signal to the third-party application 111. Upon receipt of the signal, the third-party provider application may initiate the process to cause an electronic transfer of money from a customer account to a merchant account. The transaction may include logging onto an account, reviewing the purchase, and authorizing payment to complete a transaction. Upon completion of the transaction, approval of the payment, and transfer of the money, the third-party provider application may generate and send a signal to the merchant application reporting the sale.

### Dynamic and Monitored Buttons

In an example embodiment, a “button” stored in the database 112 may include price, description, inventory, and other information related to the item offered for sale. The button may also include code such that when a button is selected by a user, the inventory information may be updated in the database 112.

In the event that the merchant database includes inventory information for the item, the third-party provider application may reduce the inventory record of the item by the number of items purchased, and generate information to be provided to a merchant in a report. The report may be sent immediately, or stored in memory to be included in a periodic report of sales, inventory, money received, and/or other information related to the sale of the item which is tracked, stored, and reported by the third-party provider.

In an example embodiment, if inventory for the item remains, the button may continue to appear on a webpage which may be accessed for additional purchases of the item. In the event that the inventory is low or depleted, information related to the low inventory, number of items remaining in inventory, or the lack of inventory available for sale may appear on the webpage on or associated with the button. A purchaser may take this information into account in making a purchasing decision.

In an example embodiment, if inventory is below a certain threshold or is depleted, the third-party provider application may generate a message to be communicated to the merchant. The low threshold that triggers such a report may be agreed upon or provided by the merchant during setup of the account or input of the item listing information. A merchant may elect the inventory control and reporting service, or may opt to not use the service. The particular services available from the third-party provider and selected by a merchant may affect the pricing for services provided to the merchant.

In an example embodiment, the third-party provider may have an application that notifies the merchant when certain conditions are met. The conditions that may cause automatic notification may include, for example, low inventory, depleted inventory, high volume purchasing, or other conditions that may be of interest to a merchant. The third-party provider may therefore provide business support related to inventory control, logistics, purchasing, and marketing. Such support may be particularly important for small merchants whose business may not be sophisticated. On an enterprise level, such support may be valuable to a business that may want to make inventory control and the collection of certain marketing data more efficient.

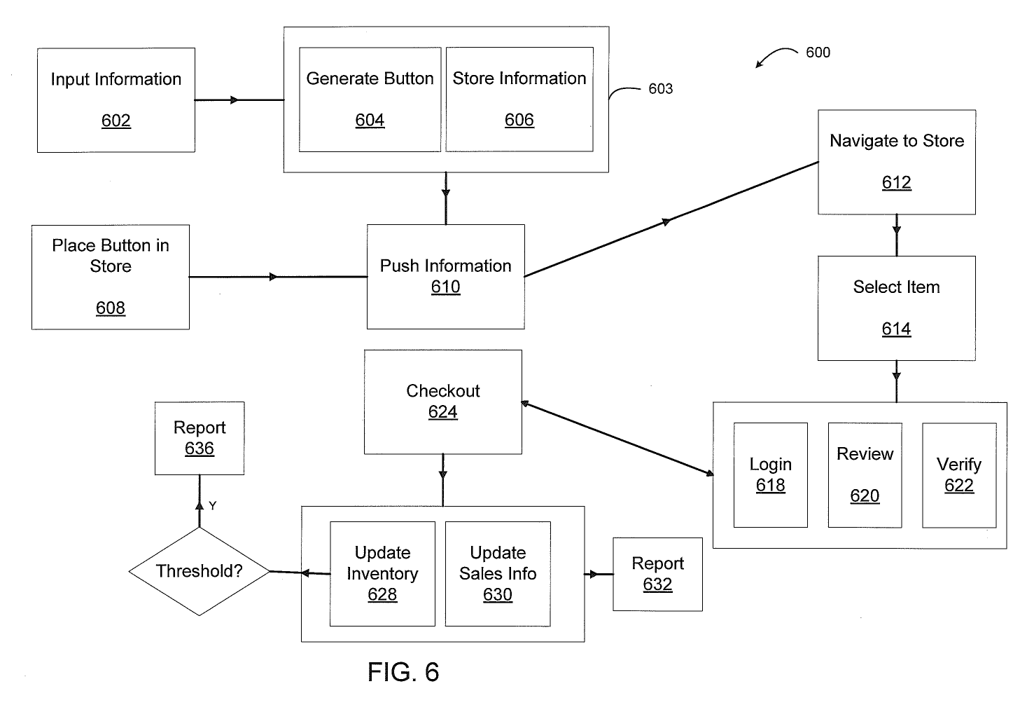

FIG. 6 illustrates a method 600 for providing a dynamic and monitored payment button system. In an example embodiment, a merchant may enter information 602 related to an item to be offered for sale, for example through a button module or API. A third-party provider application running on the third party provider server may receive and process 603 the information. Processing the information 603 may include issuing a unique identifier for the item, generating 604 a button, and storing 606 the information, including the button and the unique identifier. The third-party provider application may create a new merchant database for a newly registered merchant, or store the item listing in a merchant database previously created in the database. The information stored in any suitable memory component may include a unique identifier associated with a particular merchant and goods associated with the button. The memory component is searchable and readable so that the third party provider can access information associated with the unique identifier.

Once stored, the merchant may place 608 a stored button in a network-based store, for example by copying button code provided by the third-party provider and pasting the button into code representative of the network-based code, for example HTML. The third-party provider application may then push 610 the information related to the corresponding item to the network-based store where it may be accessible to customers accessing the network with a user device.

In an example embodiment, a user may navigate 612 to a network-based store, for example by accessing a website through a browser, and view a display with a link or button for initiating a purchase transaction for an item offered for sale. The user may select 614 the link or button to initiate the purchase transaction. The user may then execute the necessary steps, such as login 618, review 620, and verify 622, prior to checkout 624. The process may include registering with the third party payment provider and logging into the account 618 or logging into a pre-existing account, reviewing the purchase information 620, and verifying 622 or authorizing payment.

After the checkout 624 has been completed both at the user device and at the third-party provider, the third-party provider may update information related to the transaction. For example, the third-party provider may update inventory 628 and/or sales information 630, including for example total sales, marketing information, or other information related to the transaction. Such information may be stored, analyzed, and reported 632 to the merchant. The third-party provider may also update inventory information 628 in the event that the item listing included inventory information. In an example embodiment, the third-party provider may compare the updated inventory information to a predetermined threshold of inventory and may report 636 desired or relevant information to the merchant. In one embodiment, low or expired inventory is reported to the merchant. The report 636 may be made immediately if the inventory falls below a predetermined or merchant-set threshold. In other embodiments, the inventory information may be saved and reported 632 to the merchant at a pre-determined interval or immediately, depending on how the merchant set up their account. Reporting may be in any suitable format, such as in an email.

In an example embodiment, the systems and method described above may reduce the risk of fraudulent changes being made to the code of a network-based store and may reduce the risk of resultant fraudulent purchases. The systems and methods described above may make it more convenient for a merchant to generate buttons or links for placement on a network-based store, for example by permitting a merchant to automatically add buttons to a “my saved buttons” file in their third-party provider account. The systems and methods may make it more convenient for a merchant to create similar buttons, may reduce the likelihood of input errors in creating buttons, and may permit a merchant to edit buttons more conveniently and with less risk of error after a button has been created.

The systems and methods described above may also aid a merchant in tracking inventory, tracking sales, tracking profit and loss, and compiling detailed profit/loss reports related to certain items or classes of items, and in the collection and analysis of marketing information related to items offered for sale and/or sold through a network-based store.

In implementation of the various embodiments, the user device or the merchant server may comprise a personal computing device, such as a personal computer, laptop, PDA, cellular phone or other personal computing or communication devices. The merchant server or the third-party server may comprise a computer, server, or combination or network of computing devices such as a servers, computers, or processors, which in combination perform the operations described herein.

In this regard, a computer system may include a bus or other communication mechanism for communicating information, which interconnects subsystems and components, such as processing component (e.g., processor, micro-controller, digital signal processor (DSP), etc.), system memory component (e.g., RAM), static storage component (e.g., ROM), disk drive component (e.g., magnetic or optical), network interface component (e.g., modem or Ethernet card), display component (e.g., CRT or LCD), input component (e.g., keyboard or keypad), and/or cursor control component (e.g., mouse or trackball). In one embodiment, disk drive component may comprise a database having one or more disk drive components.

The computer system may perform specific operations by processor and executing one or more sequences of one or more instructions contained in a system memory component. Such instructions may be read into the system memory component from another computer readable medium, such as static storage component or disk drive component. In other embodiments, hard-wired circuitry may be used in place of or in combination with software instructions to implement the invention.

Logic may be encoded in a computer readable medium, which may refer to any medium that participates in providing instructions to the processor for execution. Such a medium may take many forms, including but not limited to, non-volatile media, volatile media, and transmission media. In various implementations, non-volatile media includes optical or magnetic disks, such as disk drive component, volatile media includes dynamic memory, such as system memory component, and transmission media includes coaxial cables, copper wire, and fiber optics, including wires that comprise bus. In one example, transmission media may take the form of acoustic or light waves, such as those generated during radio wave and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes; RAM, PROM, EPROM, FLASH-EPROM, any other memory chip or cartridge, carrier wave, or any other medium from which a computer is adapted.

In various embodiments, execution of instruction sequences for practicing the invention may be performed by a computer system. In various other embodiments, a plurality of computer systems coupled by communication link (e.g., LAN, WLAN, PTSN, or various other wired or wireless networks) may perform instruction sequences to practice the invention in coordination with one another.

Computer system may transmit and receive messages, data, information and instructions, including one or more programs (i.e., application code) through communication link and communication interface. Received program code may be executed by processor as received and/or stored in disk drive component or some other non-volatile storage component for execution.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present invention to the precise forms or particular fields of use disclosed. It is contemplated that various alternate embodiments and/or modifications to the present invention, whether explicitly described or implied herein, are possible in light of the disclosure. Having thus described various example embodiments of the disclosure, persons of ordinary skill in the art will recognize that changes may be made in form and detail without departing from the scope of the invention. Thus, the invention is limited only by the claims.

What is claimed is:

1. A system for facilitating on-line financial transactions, comprising:
a memory for storing a database; and
a first server in communication with a second server over a network, wherein the first server has machine-readable instructions stored thereon for performing the following steps:
receiving information related to an item to be offered for sale on a merchant website;
generating an item listing from the information;
storing the item listing in the database;
generating a button code and a unique identifier corresponding to the item listing; and
pushing information in the item listing to the merchant website for display on a user device accessing the merchant website.

2. The system of claim 1, wherein the item listing comprises at least one of price, tax rate, shipping costs, inventory, and options.

3. The system of claim 1, wherein the information comprises inventory information; and wherein the machine-readable instructions further perform the step of updating the inventory information responsive to a sale of the item.

4. The system of claim 1, wherein the information comprises updated inventory information; and wherein the machine-readable instructions further perform the steps of generating an inventory notice when the updated inventory reaches a threshold value.

5. The system of claim 1, wherein the machine-readable instructions further perform the step of recording information related to a sale of the item, wherein the information related to the sale of the item includes at least one of a price for the item, a payment status for the item, a cost of the item, tax paid for the item, a number of the item sold, and inventory information for the item.

6. The system of claim 5, wherein the machine-readable instructions further perform the step of generating a financial report based on the information related to the sale of the item.

7. The system of claim 1, wherein the machine-readable instructions further perform the following steps:
receiving a request to purchase the item from a customer; and
transferring payment for the item from a customer account to a merchant account responsive to the request to purchase.

8. The system of claim 7, wherein the system records information related to the purchase.

9. The system of claim 8, wherein the information related to the purchase includes at least one of a number purchased and a price paid.

10. The system of claim 1, wherein the machine-readable instructions further perform the step of providing access to the item listing when a user is authenticated.

11. The system of claim 10, wherein the access comprises allowing the user to change data in the item listing.

12. A device for facilitating on-line financial transactions, the device having machine-readable instructions stored thereon for performing the following steps:
transmitting information related to an item to be offered for sale on a merchant website;
receiving a unique identifier corresponding to the item to be offered for sale;
requesting a button to be generated corresponding to the item to be offered for sale; and
receiving code corresponding to a button to be place on the merchant website for displaying an offer to sell the item and for initiation of purchase and payment transactions related to the purchase of the item.

13. The device of claim 12, wherein the information related to the item comprises at least one of a price, inventory information, purchase options, and cost.

14. The device of claim 12, wherein the machine-readable instructions further perform the step of updating previously input information related to the item.

15. The device of claim 12, wherein the machine-readable instructions further perform the step of saving a template to be used for creating buttons for additional items to be offered for sale.

16. The device of claim 12, wherein the machine-readable instructions permit a user to customize an appearance of the button.

17. A method of providing third-party payment services, comprising:
storing information related to an item to be offered for sale;
providing a button corresponding to the item to be offered for sale and to be placed on a network-based store;
pushing information related to the item to the network-based store;
providing payment services for purchase of the item when a customer selects the item for purchase when viewing the network-based store; and
recording information related to the purchase.

18. The method of claim 17, wherein the stored information comprises inventory information, and wherein recording information related to the purchase comprises updating the inventory information.

19. The method of claim 17, wherein the stored information comprises an updated inventory for the item; and further comprising generating an inventory notice when the updated inventory reaches a threshold value.

20. The method of claim 17, wherein recording information related to the purchase comprises at least one of recording a price for the item, recording a payment status for the item, recording a cost of the item, recording tax paid for the item, recording a number of the item sold, and recording inventory information for the item.

21. The method of claim 20, further comprising generating a financial report based on the recorded information related to the purchase.

22. The method of claim 17, wherein providing the button comprises receiving input from a merchant and generating the button responsive to the input from the merchant.

23. The method of claim 17, further comprising generating a unique identifier associated with the button.
